(19) United States
(12) Patent Application Publication
(10) Pub. No.: US 2024/0264699 A1
(43) Pub. Date: Aug. 8, 2024

(54) ELECTRONIC APPARATUS AND METHOD OF DETECTING A GESTURE INPUT ON ELECTRONIC APPARATUS

(71) Applicants: Chengdu BOE Optoelectronics Technology Co., Ltd., Chengdu, Sichuan (CN); BOE Technology Group Co., Ltd., Beijing (CN)

(72) Inventors: Liang Xia, Beijing (CN); Guoqiang Tang, Beijing (CN); Kuo Sun, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 18/041,688

(22) PCT Filed: Jun. 29, 2022
(86) PCT No.: PCT/CN2022/102399

§ 371 Date: Feb. 14, 2023

(51) Int. Cl. G06F 3/041; G01J 5/00; G01J 5/10; G06F 3/01

(52) U.S. Cl. CPC G06F 3/0418; G01J 5/0025; G01J 5/10; G06F 3/017; G06F 3/0412; G01J 2005/106; G06F 2203/04108

(57) ABSTRACT

An electronic apparatus is provided. The electronic apparatus includes a pyroelectric layer including a plurality of pyroelectric blocks in an array, configured to detect thermal radiation from a gesture; a first electrode layer including a plurality of first electrodes, a respective first electrode of the plurality of first electrodes electrically connected to multiple pyroelectric blocks; a second electrode layer including a plurality of second electrodes, a respective second electrode of the plurality of second electrodes electrically connected to multiple pyroelectric blocks; and a first circuit configured to receive a first signal transmitted from the plurality of first electrodes and the plurality of second electrodes, and configured to detect a gesture input on the electronic apparatus upon receiving the first signal.

### TECHNICAL FIELD

The present invention relates to human-machine interaction and gesture detection technology, more particularly, to an electronic apparatus and a method of detecting a gesture input on an electronic apparatus.

### BACKGROUND

Various technologies have been employed to facilitate human-machine interaction. For example, an electronic apparatus could be voice-controlled. Moreover, a display panel may be implemented with touch control structure, thus enabling touch control of the display panel. However, touch control requires contacts between human and machine. Voice control may not always be able to achieve accurate results, particularly when a user is in a noisy environment. Thus, there is a need for alternative control technologies that, among other features, allow non-contact human-machine interaction, high accuracy, and compatible with apparatus having display panels.

### SUMMARY

In one aspect, the present disclosure provides an electronic apparatus, comprising a pyroelectric layer comprising a plurality of pyroelectric blocks in an array, configured to detect thermal radiation from a gesture; a first electrode layer comprising a plurality of first electrodes, a respective first electrode of the plurality of first electrodes electrically connected to multiple pyroelectric blocks; a second electrode layer comprising a plurality of second electrodes, a respective second electrode of the plurality of second electrodes electrically connected to multiple pyroelectric blocks; and a first circuit configured to receive a first signal transmitted from the plurality of first electrodes and the plurality of second electrodes, and configured to detect a gesture input on the electronic apparatus upon receiving the first signal.

Optionally, the electronic apparatus further comprises a non-transitory memory comprising a first database configured to store data on a distribution pattern of heat generated by the electronic apparatus in operation over the pyroelectric layer.

Optionally, the electronic apparatus further comprises a second circuit configured to convert the first signal into a second signal by canceling a noise in the first signal contributed by the heat generated by the electronic apparatus in operation over the pyroelectric layer.

Optionally, the electronic apparatus further comprises a non-transitory memory comprising a second database configured to store data on correspondence between a plurality of gesture inputs and a plurality of commands.

Optionally, the electronic apparatus further comprises a second circuit configured to generate a command signal based on the correspondence and upon detection of the gesture input, and drive the electronic apparatus to perform an operation based on a command corresponding to the gesture input.

Optionally, the operation comprises activating a virtual object displayed on a display panel.

Optionally, the electronic apparatus further comprises a display panel configured to display an image in a display area; wherein the plurality of pyroelectric blocks are at least partially in the display area.

Optionally, the electronic apparatus further comprises a touch control structure on a light emitting side of the display panel; wherein the pyroelectric layer, the first electrode layer, and the second electrode layer are on a side of the touch control structure away from the display panel.

Optionally, the display area comprises a plurality of subpixel regions and an inter-subpixel region; and the plurality of pyroelectric blocks, the plurality of first electrodes, and the plurality of second electrodes are in the inter-subpixel region.

Optionally, the plurality of first electrodes and the plurality of second electrodes cross over each other forming a plurality of intersections; and the plurality of pyroelectric blocks are in the plurality of intersections, respectively, and between the first electrode layer and the second electrode layer.

Optionally, the electronic apparatus further comprises a support structure on a side opposite to a light emitting side of the display panel; wherein the pyroelectric layer, the first electrode layer, and the second electrode layer are integrated into the support structure.

Optionally, the support structure comprises a flexible base substrate; the first electrode layer is on a side of the flexible base substrate closer to the display panel; the pyroelectric layer is on a side of the first electrode layer away from the flexible base substrate; and the second electrode layer is on a side of the pyroelectric layer away from the first electrode layer.

Optionally, the flexible base substrate is a back film of the display panel; and the pyroelectric layer, the first electrode layer, and the second electrode layer are between the back film and the display panel.

Optionally, the support structure further comprises a metal support layer on a side of the second electrode layer away from the flexible base substrate; a foam layer on a side of the metal support layer away from the second electrode layer; and an adhesive layer on a side of the foam layer away from the metal support layer, adhering the support structure to the display panel.

In another aspect, the present disclosure provides a method of detecting a gesture input on an electronic apparatus, wherein the electronic apparatus comprises a pyroelectric layer comprising a plurality of pyroelectric blocks in an array; a first electrode layer comprising a plurality of first electrodes, a respective first electrode of the plurality of first electrodes electrically connected to multiple pyroelectric blocks; a second electrode layer comprising a plurality of second electrodes, a respective second electrode of the plurality of second electrodes electrically connected to multiple pyroelectric blocks; and a first circuit connected to the plurality of first electrodes and the plurality of second electrodes; the method comprises detecting thermal radiation from a gesture by the pyroelectric layer; receiving, by the first circuit, a first signal from the plurality of first electrodes and the plurality of second electrodes; and detecting the gesture input on the electronic apparatus upon receiving the first signal.

Optionally, the method further comprises establishing a first database configured to store data on a distribution pattern of heat generated by the electronic apparatus in operation over the pyroelectric layer.

Optionally, the method further comprises converting the first signal into a second signal by canceling a noise in the first signal contributed by the heat generated by the electronic apparatus in operation over the pyroelectric layer.

Optionally, the method further comprises establishing a second database configured to store data on correspondence between a plurality of gesture inputs and a plurality of commands.

Optionally, the method further comprises generating a command signal based on the correspondence and upon detection of the gesture input, and drive the electronic apparatus to perform an operation based on a command corresponding to the gesture input.

Optionally, the operation comprises activating a virtual object displayed on a display panel.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating the structure of an electronic apparatus in some embodiments according to the present disclosure.

FIG. 2 is a cross-sectional view along an A-A′ line in FIG. 1.

FIG. 3 is a schematic diagram illustrating the structure of an electronic apparatus in some embodiments according to the present disclosure.

FIG. 4 is a schematic diagram illustrating a display area and a peripheral area in a display panel in some embodiments according to the present disclosure.

FIG. 5A illustrates a detailed structure in a display region in a display panel in some embodiments according to the present disclosure.

FIG. 5B illustrates a detailed structure in a display region in a display panel in some embodiments according to the present disclosure.

FIG. 6 illustrates an arrangement of a stacked structure in an electronic apparatus in some embodiments according to the present disclosure.

FIG. 7 is a cross-sectional view of an electronic apparatus in some embodiments according to the present disclosure.

FIG. 8 is a schematic diagram illustrating the structure of an electronic apparatus in some embodiments according to the present disclosure.

FIG. 9 illustrates plurality of subpixel regions and an inter-subpixel region in some embodiments according to the present disclosure.

FIG. 10 illustrates the structure of a pyroelectric structure in some embodiments according to the present disclosure.

FIG. 11 is a schematic diagram of a zoom-in region in an electronic apparatus in some embodiments according to the present disclosure.

FIG. 12 illustrates an arrangement of a stacked structure in an electronic apparatus in some embodiments according to the present disclosure.

FIG. 13 is a cross-sectional view of an electronic apparatus in some embodiments according to the present disclosure.

FIG. 14 is a cross-sectional view of an electronic apparatus in some embodiments according to the present disclosure.

FIG. 15 is a schematic diagram illustrating the structure of an electronic apparatus in some embodiments according to the present disclosure.

FIG. 16 is a flow chart illustrating a process of detecting a gesture input on an electronic apparatus in some embodiments according to the present disclosure.

FIG. 17 is a flow chart illustrating a process of detecting a gesture input on an electronic apparatus in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

The present disclosure provides, inter alia, an electronic apparatus and a method of detecting a gesture input on an electronic apparatus that substantially obviate one or more of the problems due to limitations and disadvantages of the related art. In one aspect, the present disclosure provides an electronic apparatus. In some embodiments, the electronic apparatus includes a pyroelectric layer comprising a plurality of pyroelectric blocks in an array, configured to detect thermal radiation from a gesture; a first electrode layer comprising a plurality of first electrodes, a respective first electrode of the plurality of first electrodes electrically connected to multiple pyroelectric blocks; a second electrode layer comprising a plurality of second electrodes, a respective second electrode of the plurality of second electrodes electrically connected to multiple pyroelectric blocks; and a first circuit configured to receive a first signal transmitted from the plurality of first electrodes and the plurality of second electrodes, and configured to detect a gesture input on the electronic apparatus upon receiving the first signal.

As used herein, the term “pyroelectric” relates to a material such as a material having a polar crystalline structure, being capable of generating a temporary voltage or current because of a temperature variation, e.g., by heating or cooling the substance over a time interval. The temperature variation may slightly modify positions of atoms being located within the polar crystal structure in a fashion that a polarization of the pyroelectric material may be altered, which, in turn, may result in an observation of the temporary voltage or current. Because of this characteristics, the pyroelectric material is capable of detecting a thermal radiation.

Various appropriate pyroelectric materials and various appropriate fabricating methods may be used to make the pyroelectric layer PEL. For example, a pyroelectric material may be deposited on the substrate by a plasma-enhanced chemical vapor deposition (PECVD) process to form a pyroelectric material layer, and the pyroelectric material layer is then patterned to form the plurality of pyroelectric blocks. Examples of appropriate pyroelectric materials include aluminum nitride, zinc oxide, a pyroelectric polymer such as polyvinylidene fluoride, a PZT-type ceramic material such as lead zirconium titanium, and a TGS- or LiTaO3-type crystalline element such as triglycine sulfate.

Various appropriate electrode materials and various appropriate fabricating methods may be used to make the first electrode layer EL1 and the second electrode layer EL2. For example, an electrode material may be deposited on the substrate by, e.g., sputtering or vapor deposition, and patterned by, e.g., lithography such as a wet etching process to form the first electrode layer EL1 and the second electrode layer EL2. Examples of appropriate conductive electrode materials include, but are not limited to, aluminum, chromium, tungsten, titanium, tantalum, molybdenum, copper, and alloys or laminates containing the same. In another example, a non-metal transparent electrode material may be used. Examples of appropriate non-metal transparent electrode materials include, but are not limited to, various transparent metal oxide electrode materials and transparent nano-carbon tubes. Examples of transparent metal oxide materials include, but are not limited to, indium tin oxide, indium zinc oxide, indium gallium oxide, and indium gallium zinc oxide.

The inventors of the present disclosure discover that, surprisingly and unexpectedly, by including a pyroelectric with a unique structure, the electronic apparatus may be used for detecting a gesture input.

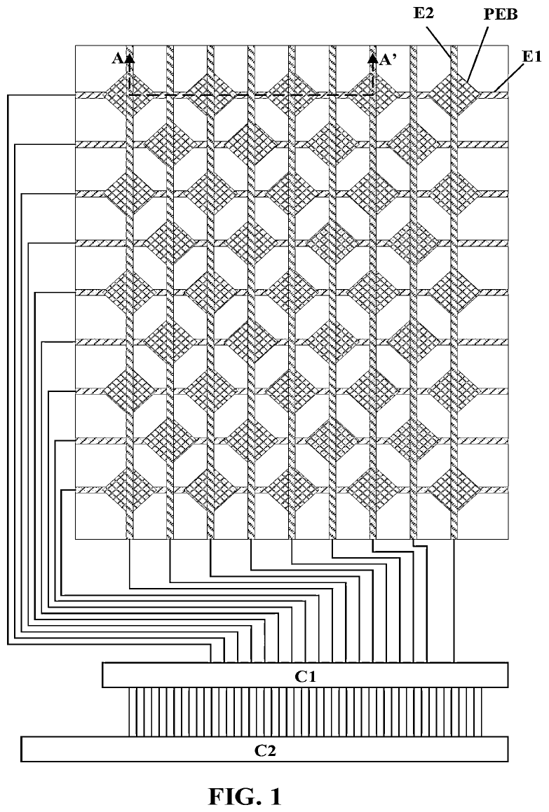

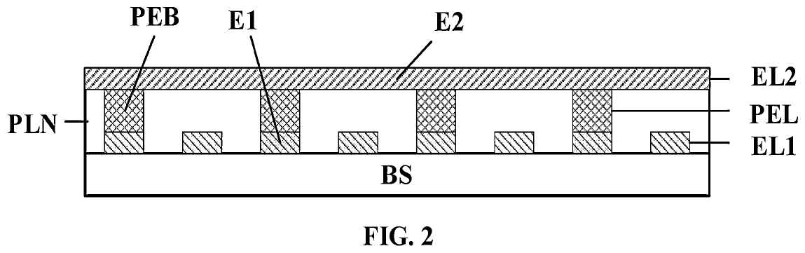

FIG. 1 is a schematic diagram illustrating the structure of an electronic apparatus in some embodiments according to the present disclosure. FIG. 2 is a cross-sectional view along an A-A′ line in FIG. 1. Referring to FIG. 1 and FIG. 2, the electronic apparatus in some embodiments includes a pyroelectric layer PEL, a first electrode layer EL1, and a second electrode layer EL2. Optionally, the first electrode layer EL1 is on a base substrate BS, the pyroelectric layer PEL is on a side of the first electrode layer EL1 away from the base substrate BS, and the second electrode layer EL2 is on a side of the pyroelectric layer PEL away from the first electrode layer EL1.

In some embodiments, the pyroelectric layer PEL includes a plurality of pyroelectric blocks PEB arranged in an array, the first electrode layer EL1 includes a plurality of first electrodes E1, and the second electrode layer EL2 includes a plurality of second electrodes E2. As shown in FIG. 1 and FIG. 2, a respective first electrode of the plurality of first electrodes E1 is electrically connected to multiple pyroelectric blocks of the plurality of pyroelectric blocks PEB. For example, the respective first electrode is electrically connected to a row of multiple pyroelectric blocks. A respective second electrode of the plurality of second electrodes E2 is electrically connected to multiple pyroelectric blocks of the plurality of pyroelectric blocks PEB. For example, the respective second electrode is electrically connected to a column of multiple pyroelectric blocks. The plurality of first electrodes E1 are not directly connected to the plurality of second electrodes E2.

In some embodiments, the electronic apparatus further includes a planarization layer PLN between the first electrode layer EL1 and the second electrode layer EL2. By having a planarization layer PLN between the first electrode layer EL1 and the second electrode layer EL2, a respective first electrode is insulated from a respective second electrode when they cross over each other at a position where the pyroelectric blocks are absent. A thickness of the planarization layer PLN is the same as a combined thickness of the first electrode layer EL1 and the pyroelectric layer PEL, so that the plurality of second electrodes E2 are formed on a side of the planarization layer PLN and the plurality of pyroelectric blocks PEB away from the base substrate BS. A respective second electrode may be formed to be in contact with multiple pyroelectric blocks in a column.

In some embodiments, the electronic apparatus further includes a first circuit C1. The plurality of first electrodes E1 and the plurality of second electrodes E2 are connected to the first circuit C1. In one example, the first circuit C1 is a sensing integrated circuit. A “gesture” in some embodiments may be considered as a contactless “touch” on the electronic apparatus. When a user applies a gesture near the electronic apparatus, one or more pyroelectric blocks within a threshold distance with respect to the gesture can detect the thermal radiation from the gesture (e.g., from a finger or palm of a user). A respective pyroelectric block within the threshold distance generates an electric signal such as a voltage signal, the electric signal is transmitted to the first circuit C1 through a respective first electrode and a respective second electrode connected to the respective pyroelectric block. The first circuit C1 receives the signal. A “touch” position of the contactless “touch” by the gesture can be determined based on the positions of the respective first electrode and the respective second electrode connected to the respective pyroelectric block. The contactless “touch”, when detected, may be used as an input on the electronic apparatus that prompts a command.

In some embodiments, the first circuit C1 is configured to receive a first signal transmitted from the plurality of first electrodes E1 and the plurality of second electrodes E2, and configured to detect a gesture input on the electronic apparatus upon receiving the first signal. Optionally, the first signal is an original signal that includes a true signal induced by the gesture and a noise signal contributed by the environment.

The inventors of the present disclosure discover that one of the most significant noise is the heat generated by the electronic apparatus when it is in operation. The inventors of the present disclosure discover that the sensitivity of gesture detection can be improved by reducing or eliminating the noise introduced by the heat generated by the electronic apparatus when it is in operation. In some embodiments, the electronic apparatus further includes a non-transitory memory including a first database configured to store data on a distribution pattern of heat generated by the electronic apparatus in operation over the pyroelectric layer.

The data on the distribution pattern of heat generated by the electronic apparatus in operation over the pyroelectric layer may be measured at any appropriate time. In one example, the data may be measured every time when the electronic apparatus is starting up. In another example, the data may be updated periodically when the electronic apparatus is on. In another example, the data may be measured during a calibration process.

Other environmental noises may be filtered in a similar fashion. In some embodiments, the first database is configured to store data on heat generated by one or more environmental objects that induces an electric signal in one or more pyroelectric blocks. The electronic apparatus is configured to measure data on heat generated by one or more environmental objects periodically and in real time.

In some embodiments, the electronic apparatus further includes a second circuit C2. The second circuit C2 is electrically connected to the first circuit C1, and configured to receive the first signal from the first circuit C1. In one example, the second circuit may be a driving integrated circuit for the electronic apparatus, and configured to drive the electronic apparatus to perform an operation.

Optionally, the first circuit C1 and the second circuit C2 are two separate circuits.

Optionally, the first circuit C1 and the second circuit C2 parts of a same circuit, e.g., parts of a same integrated circuit.

In some embodiments, the second circuit C2 is configured to convert the first signal into a second signal by canceling a noise in the first signal transmitted from the first circuit C1. In one example, the noise includes a noise contributed by the heat generated by the electronic apparatus in operation over the pyroelectric layer. In another example, the noise includes a noise contributed by one or more environmental objects other than the electronic apparatus. Optionally, the one or more environmental objects may be a heat source. Optionally, the one or more environmental objects may be a cold source. Examples of environmental objects include sunlight, air flow (hot air or cold air), a heating light source, etc.

In some embodiments, the electronic apparatus further includes a non-transitory memory including a second database configured to store data on correspondence between a plurality of gesture inputs and a plurality of commands. Each gesture input corresponds to one or more commands. Each command corresponds to one or more gesture inputs. For example, a “pointing” gesture may correspond to a click by a mouse input device, or a touch on a touch control panel. A left or right “swipe” gesture may correspond to navigating to a previous page or a next page. An upward or downward “swipe” gesture may correspond to moving a page upward or downward. A “circling” gesture may correspond to a movement from one displayed virtual object to another displayed virtual object.

In some embodiments, the second circuit C2 is configured to generate a command signal based on the correspondence stored in the second database, and upon detection of the gesture input. Optionally, the second circuit C2 is configured to drive the electronic apparatus to perform an operation based on a command corresponding to the gesture input. In one example, the operation may include activating a virtual object displayed on a display panel. The term “command signal” refers to any signal that is recognizable by a processor as an instruction to perform an operation or function performable by the processor.

The electronic apparatus of the present disclosure finds a wide variety of applications. In one example, the electronic apparatus is a vehicular display apparatus, the gesture control enabled by the present disclosure allows a user to provide gesture input to the vehicular display apparatus, particularly when other methods of control (e.g., touch control or voice control) cannot be easily applied. In another example, the electronic apparatus is a gym equipment such as a treadmill. Touch control of the gym equipment is difficult when the user is exercising, and the noisy ambient sound in a gym makes voice control infeasible. The present disclosure thus provides a highly sensitive user-machine interactive method, enhancing the safety of the user.

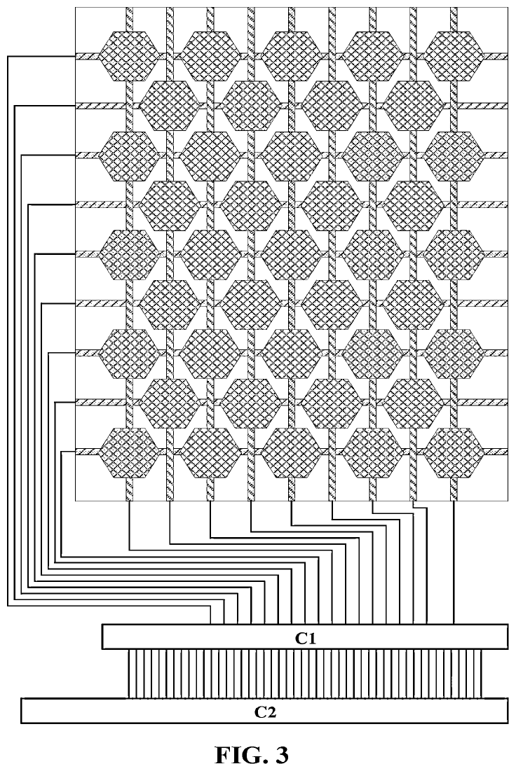

The plurality of pyroelectric blocks may have any appropriate shapes. Examples of appropriate shapes of pyroelectric blocks include a square shape, a rectangular shape, a triangular shape, a circular shape, an elliptical shape, a hexagonal shape, a pentagonal shape, a regular polygonal shape, or an irregular shape. FIG. 1 depicts pyroelectric blocks having a diamond shape. FIG. 3 is a schematic diagram illustrating the structure of an electronic apparatus in some embodiments according to the present disclosure. FIG. 3 depicts pyroelectric blocks having a hexagonal shape.

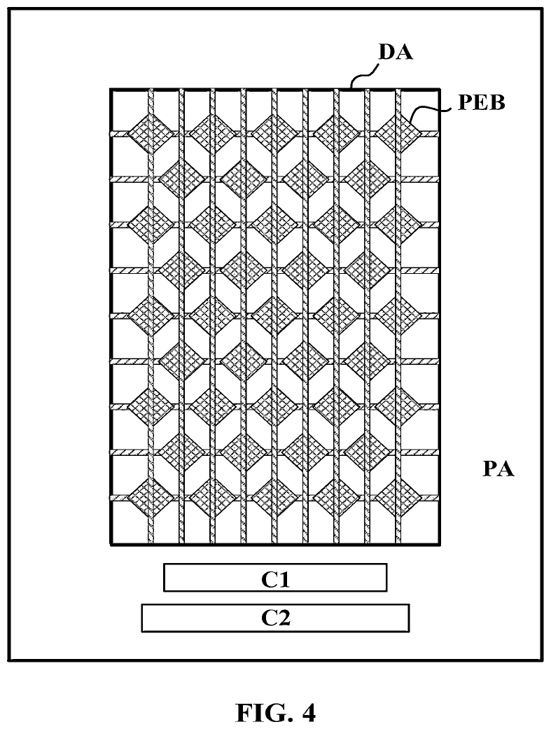

In some embodiments, the electronic apparatus further includes a display panel configured to display an image in a display area. Optionally, the plurality of pyroelectric blocks are at least partially in the display area. FIG. 4 is a schematic diagram illustrating a display area and a peripheral area in a display panel in some embodiments according to the present disclosure. Referring to FIG. 4, in some embodiments, the electronic apparatus includes a display area DA and a peripheral area PA. Optionally, the display area DA is substantially the same as a touch control area in which a touch control structure is present. The plurality of pyroelectric blocks PEB are at least partially in the display area DA. Optionally, the plurality of pyroelectric blocks PEB are arranged in an array that is entirely in the display area DA.

As used herein, the term “display area” refers to an area of an electronic apparatus where image is actually displayed. Optionally, the display area may include both a subpixel region and an inter-subpixel region. A subpixel region refers to a light emission region of a subpixel, such as a region corresponding to a pixel electrode in a liquid crystal display or a region corresponding to a light emissive layer in an organic light emitting diode display panel. An inter-subpixel region refers to a region between adjacent subpixel regions, such as a region corresponding to a black matrix in a liquid crystal display or a region corresponding a pixel definition layer in an organic light emitting diode display panel. Optionally, the inter-subpixel region is a region between adjacent subpixel regions in a same pixel. Optionally, the inter-subpixel region is a region between two adjacent subpixel regions from two adjacent pixels.

As used herein the term “peripheral area” refers to an area of an electronic apparatus where various circuits and wires are provided to transmit signals to the electronic apparatus. To increase the transparency of the electronic apparatus, non-transparent or opaque components of the electronic apparatus (e.g., battery, printed circuit board, metal frame), can be disposed in the peripheral area rather than in the display areas.

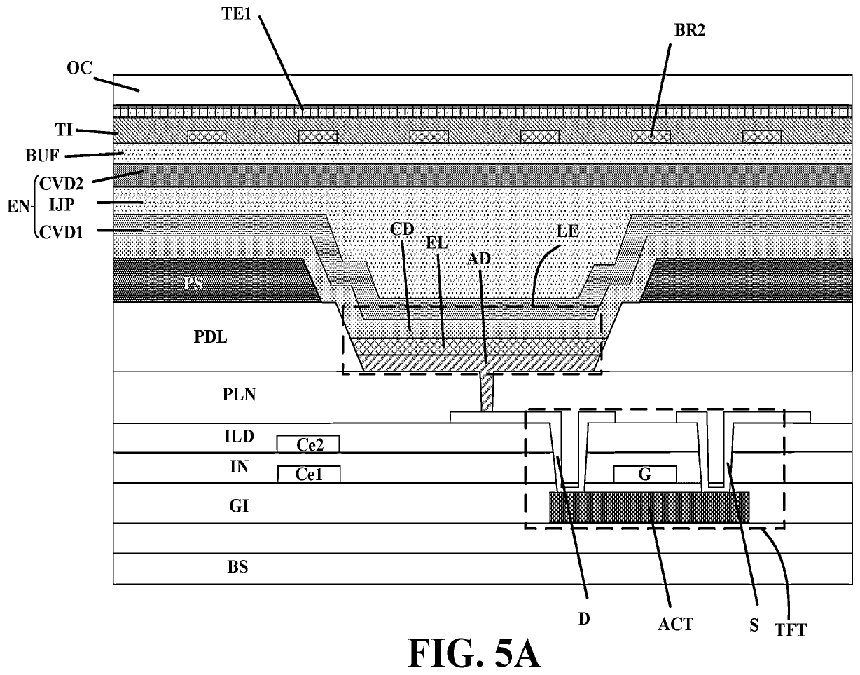

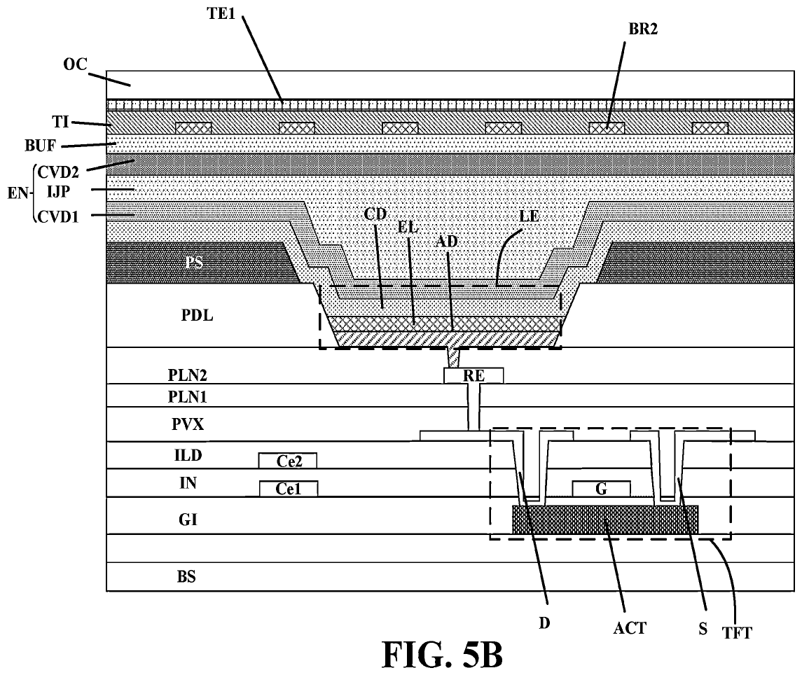

Various implementations of the present display panel may be practiced. FIG. 5A illustrates a detailed structure in a display region in a display panel in some embodiments according to the present disclosure. Referring to FIG. 5A, the display panel in the display region in some embodiments includes a base substrate BS (e.g., a flexible base substrate); an active layer ACT of a respective one of a plurality of thin film transistors TFT on the base substrate BS; a gate insulating layer GI on a side of the active layer ACT away from the base substrate BS; a gate electrode G and a first capacitor electrode Ce1 (both are parts of a first gate metal layer) on a side of the gate insulating layer GI away from the base substrate BS; an insulating layer IN on a side of the gate electrode G and the first capacitor electrode Ce1 away from the gate insulating layer GI; a second capacitor electrode Ce2 (a part of a second gate metal layer) on a side of the insulating layer IN away from the gate insulating layer GI; an inter-layer dielectric layer ILD on a side of the second capacitor electrode Ce2 away from the gate insulating layer GI; a source electrode S and a drain electrode D (parts of a first SD metal layer) on a side of the inter-layer dielectric layer ILD away from the gate insulating layer GI; a planarization layer PLN on a side of the source electrode S and the drain electrode D away from the inter-layer dielectric layer ILD; a pixel definition layer PDL defining a subpixel aperture and on a side of the planarization layer PLN away from the base substrate BS; and a light emitting element LE in the subpixel aperture. The light emitting element LE includes an anode AD on a side of the planarization layer PLN away from the inter-layer dielectric layer ILD; a light emitting layer EL on a side of the anode AD away from the planarization layer PLN; and a cathode layer CD on a side of the light emitting layer EL away from the anode AD. The display panel in the display region further includes an encapsulating layer EN encapsulating the dummy light emitting element DLE, and on a side of the cathode layer CD away from the base substrate BS. The encapsulating layer EN in some embodiments includes a first inorganic encapsulating sub-layer CVD1 on a side of the cathode layer CD away from the base substrate BS, an organic encapsulating sub-layer IJP on a side of the first inorganic encapsulating sub-layer CVD1 away from the base substrate BS, and a second inorganic encapsulating sub-layer CVD2 on a side of the organic encapsulating sub-layer IJP away from the first inorganic encapsulating sub-layer CVD1. The display panel in the display region further includes a buffer layer BUF on a side of the encapsulating layer EN away from the base substrate BS; a plurality of second electrode bridges BR2 on a side of the buffer layer BUF away from the encapsulating layer EN; a touch insulating layer TI on a side of the plurality of second electrode bridges BR2 away from the buffer layer BUF; a plurality of first touch electrodes TE1 on a side of the touch insulating layer TI away from the buffer layer BUF; and an overcoat layer OC on a side of the plurality of first touch electrodes TE1 away from the touch insulating layer TI.

FIG. 5B illustrates a detailed structure in a display region in a display panel in some embodiments according to the present disclosure. Referring to FIG. 5B, the display panel in the display region in some embodiments includes a base substrate BS (e.g., a flexible base substrate); an active layer ACT of a respective one of a plurality of thin film transistors TFT on the base substrate BS; a gate insulating layer GI on a side of the active layer ACT away from the base substrate BS; a gate electrode G and a first capacitor electrode Ce1 (both are parts of a first gate metal layer) on a side of the gate insulating layer GI away from the base substrate BS; an insulating layer IN on a side of the gate electrode G and the first capacitor electrode Ce1 away from the gate insulating layer GI; a second capacitor electrode Ce2 (a part of a second gate metal layer) on a side of the insulating layer IN away from the gate insulating layer GI; an inter-layer dielectric layer ILD on a side of the second capacitor electrode Ce2 away from the gate insulating layer GI; a source electrode S and a drain electrode D (parts of a first SD metal layer) on a side of the inter-layer dielectric layer ILD away from the gate insulating layer GI; a passivation layer PVX on a side of the source electrode S and the drain electrode D away from the inter-layer dielectric layer ILD; a first planarization layer PLN1 on a side of the passivation layer PVX away from the inter-layer dielectric layer ILD; a second planarization layer PLN2 on side of the first planarization layer PLN1 away from the passivation layer PVX; a relay electrode RE (part of a second SD metal layer) on a side of the second planarization layer PLN2 away from the first planarization layer PLN1; a pixel definition layer PDL defining a subpixel aperture and on a side of the second planarization layer PLN2 away from the base substrate BS; and a light emitting element LE in the subpixel aperture. The light emitting element LE includes an anode AD on a side of the second planarization layer PLN2 away from the first planarization layer PLN1; a light emitting layer EL on a side of the anode AD away from the second planarization layer PLN2; and a cathode layer CD on a side of the light emitting layer EL away from the anode AD. The display panel in the display region further includes an encapsulating layer EN encapsulating the dummy light emitting element DLE, and on a side of the cathode layer CD away from the base substrate BS. The encapsulating layer EN in some embodiments includes a first inorganic encapsulating sub-layer CVD1 on a side of the cathode layer CD away from the base substrate BS, an organic encapsulating sub-layer IJP on a side of the first inorganic encapsulating sub-layer CVD1 away from the base substrate BS, and a second inorganic encapsulating sub-layer CVD2 on a side of the organic encapsulating sub-layer IJP away from the first inorganic encapsulating sub-layer CVD1. The display panel in the display region further includes a buffer layer BUF on a side of the encapsulating layer EN away from the base substrate BS; a plurality of second electrode bridges BR2 on a side of the buffer layer BUF away from the encapsulating layer EN; a touch insulating layer TI on a side of the plurality of second electrode bridges BR2 away from the buffer layer BUF; a plurality of first touch electrodes TE1 on a side of the touch insulating layer TI away from the buffer layer BUF; and an overcoat layer OC on a side of the plurality of first touch electrodes TE1 away from the touch insulating layer TI. Optionally, the display panel in the display region does not include the passivation layer PVX, e.g., the inter-layer dielectric layer ILD is in direct contact with the first planarization layer PLN1.

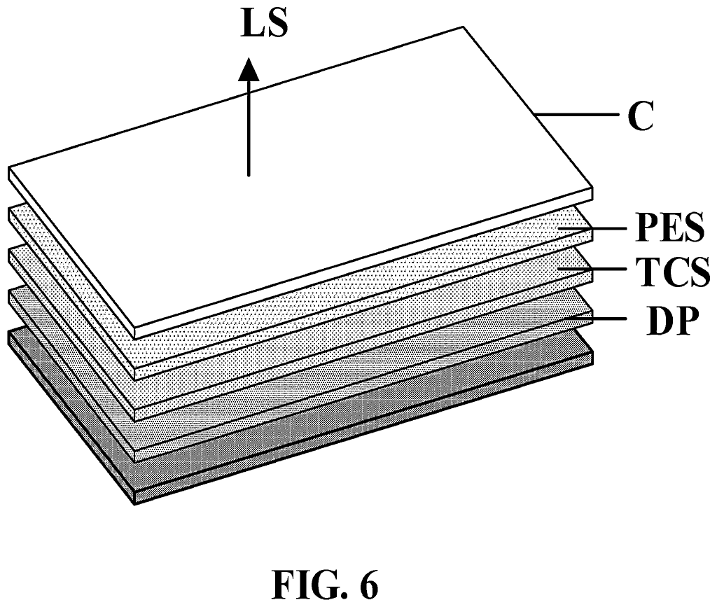

In some embodiments, the electronic apparatus further includes a touch control structure (e.g., the touch electrodes and bridges depicted in FIG. 5A and FIG. 5B) on a light emitting side of the display panel. FIG. 6 illustrates an arrangement of a stacked structure in an electronic apparatus in some embodiments according to the present disclosure. Referring to FIG. 6, the electronic apparatus in some embodiments includes a display panel DP. Optionally, on a light emitting side LS of the display panel DP, the electronic apparatus further includes a touch control structure TCS on the display panel DP, a pyroelectric structure PES on a side of the touch control structure TCS away from the display panel DP, and a cover C on a side of the pyroelectric structure PES away from the touch control structure TCS.

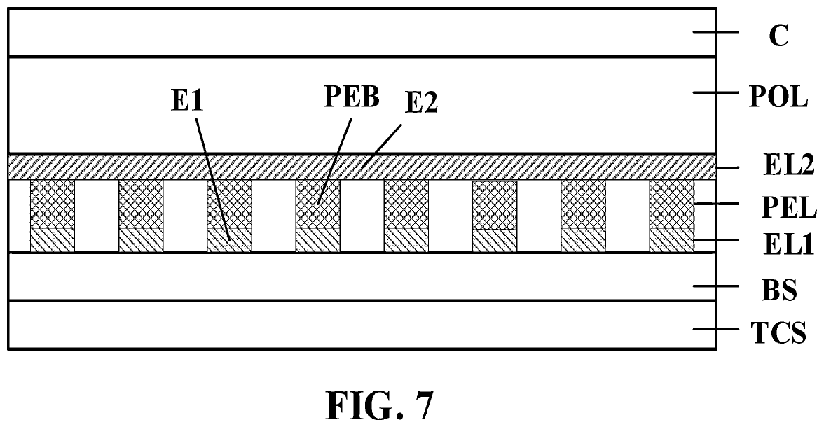

FIG. 7 is a cross-sectional view of an electronic apparatus in some embodiments according to the present disclosure. Referring to FIG. 7, the electronic apparatus in some embodiments includes a base substrate BS on the touch control structure TCS, a first electrode layer EL1 on a side of the base substrate BS away from the touch control structure TCS, a pyroelectric layer PEL on a side of the first electrode layer EL1 away from the base substrate BS, a second electrode layer EL2 on a side of the pyroelectric layer PEL away from the first electrode layer EL1, a polarizer POL on a side of the second electrode layer EL2 away from the pyroelectric layer PEL, and a cover C on a side of the polarizer POL away from the second electrode layer EL2.

In one example, the base substrate BS is a colorless polyimide layer on the touch control structure TCS.

In another example, the pyroelectric structure is formed directly on the overcoat layer (OC in FIG. 5A and FIG. 5B) that covers the touch control structure TCS. The base substrate BS in FIG. 7 is the overcoat layer on the touch control structure TCS.

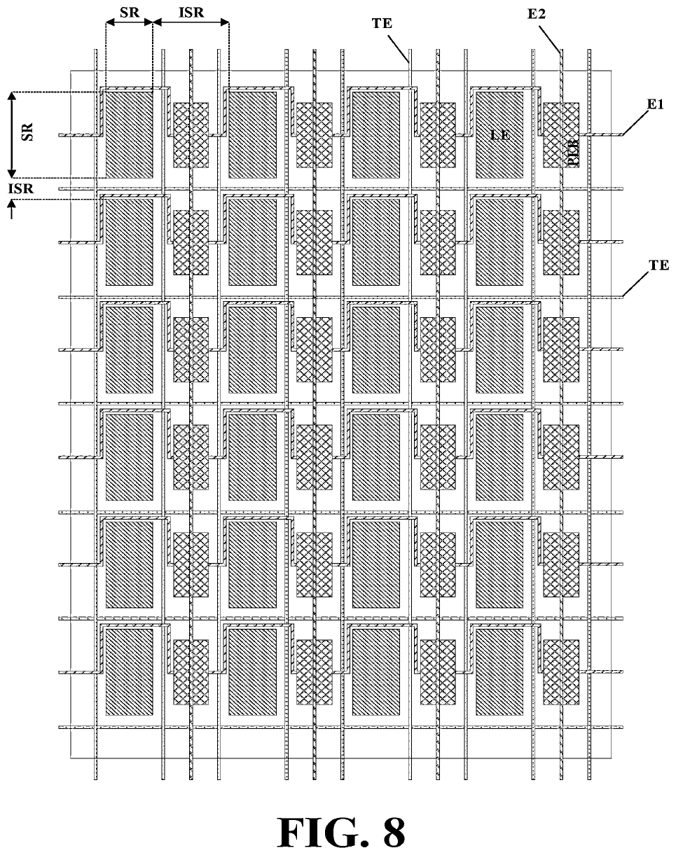

FIG. 8 is a schematic diagram illustrating the structure of an electronic apparatus in some embodiments according to the present disclosure. Referring to FIG. 7 and FIG. 8, in some embodiments, the pyroelectric layer PEL includes a plurality of pyroelectric blocks PEB arranged in an array, the first electrode layer EL1 includes a plurality of first electrodes E1, and the second electrode layer EL2 includes a plurality of second electrodes E2. As shown in FIG. 7 and FIG. 8, a respective first electrode of the plurality of first electrodes E1 is electrically connected to multiple pyroelectric blocks of the plurality of pyroelectric blocks PEB. For example, the respective first electrode is electrically connected to a row of multiple pyroelectric blocks. A respective second electrode of the plurality of second electrodes E2 is electrically connected to multiple pyroelectric blocks of the plurality of pyroelectric blocks PEB. For example, the respective second electrode is electrically connected to a column of multiple pyroelectric blocks. The plurality of first electrodes E1 are not directly connected to the plurality of second electrodes E2.

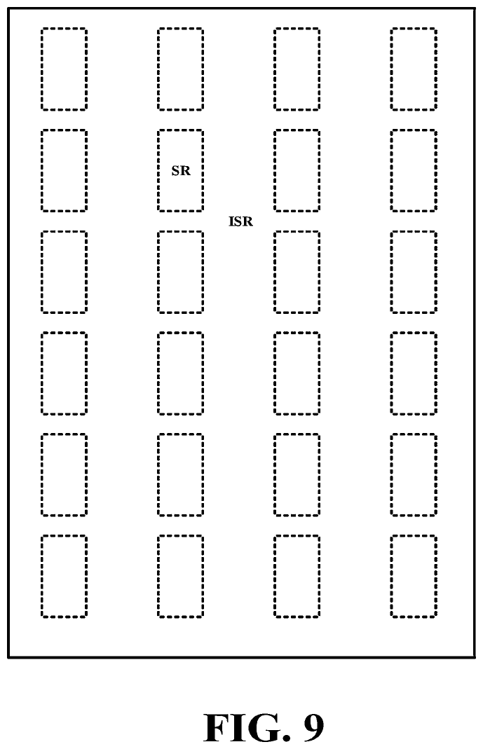

FIG. 9 illustrates plurality of subpixel regions and an inter-subpixel region in some embodiments according to the present disclosure. In some embodiments, referring to FIG. 8 and FIG. 9, the electronic apparatus includes a plurality of subpixel regions SR and an inter-subpixel region ISR. A plurality of light emitting elements LE are disposed in the plurality of subpixel regions SR, respectively. To avoid adverse effect on image display, the plurality of pyroelectric blocks PEB, the plurality of first electrodes E1, and the plurality of second electrodes E2 are in disposed the inter-subpixel region ISR. In one example as depicted in FIG. 8, a respective pyroelectric block of the plurality of pyroelectric blocks PEB is in a portion of the inter-subpixel region ISR between two adjacent subpixel regions in a row. A respective first electrode is in a portion of the inter-subpixel region ISR between two adjacent rows of subpixel regions. A respective second electrode is in a portion of the inter-subpixel region ISR between two adjacent columns of subpixel regions.

As used herein, a subpixel region refers to a light emission region of a subpixel, such as a region corresponding to a pixel electrode in a liquid crystal display panel, or a region corresponding to a light emissive layer in an organic light emitting diode display panel. Optionally, a pixel may include a number of separate light emission regions corresponding to a number of subpixels in the pixel. Optionally, the subpixel region is a light emission region of a red color subpixel. Optionally, the subpixel region is a light emission region of a green color subpixel. Optionally, the subpixel region is a light emission region of a blue color subpixel. Optionally, the subpixel region is a light emission region of a white color subpixel.

As used herein, an inter-subpixel region refers to a region between adjacent subpixel regions, such as a region corresponding to a black matrix in a liquid crystal display panel, or a region corresponding a pixel definition layer in an organic light emitting diode display panel. Optionally, the inter-subpixel region is a region between adjacent subpixel regions in a same pixel. Optionally, the inter-subpixel region is a region between two adjacent subpixel regions from two adjacent pixels. Optionally, the inter-subpixel region is a region between a subpixel region of a red color subpixel and a subpixel region of an adjacent green color subpixel. Optionally, the inter-subpixel region is a region between a subpixel region of a red color subpixel and a subpixel region of an adjacent blue color subpixel. Optionally, the inter-subpixel region is a region between a subpixel region of a green color subpixel and a subpixel region of an adjacent blue color subpixel.

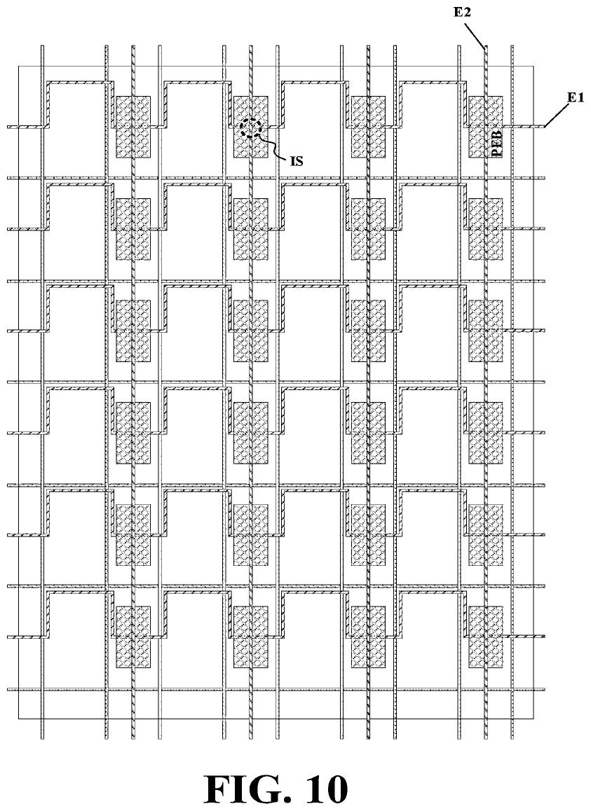

In some embodiments, the plurality of first electrodes and the plurality of second electrodes cross over each other forming a plurality of intersections. FIG. 10 illustrates the structure of a pyroelectric structure in some embodiments according to the present disclosure. Referring to FIG. 8 and FIG. 10, the plurality of first electrodes E1 and the plurality of second electrodes E2 cross over each other forming a plurality of intersections IS. The plurality of pyroelectric blocks PEB are in the plurality of intersections IS, respectively, and between the first electrode layer and the second electrode layer. In one example as depicted in FIG. 8 and FIG. 10, each pyroelectric block is in a respective intersection, and each intersection has a pyroelectric block present. Because any intersection, where the first electrode and the second electrode cross over each other, has a pyroelectric block present, there is no need to have a planarization layer to insulate the first electrode layer from the second electrode layer. In fabricating the electronic apparatus, one mask and one patterning step may be omitted.

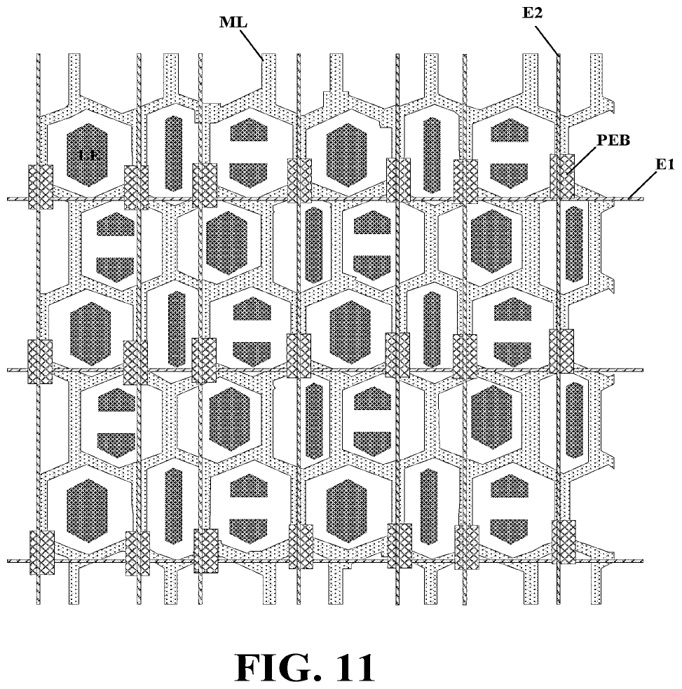

The touch control structure in some embodiments includes a plurality of touch electrodes TE. Optionally, the plurality of touch electrodes TE are disposed in the inter-subpixel region ISR. To avoid parasitic capacitance between the electrodes of the pyroelectric structure and the plurality of touch electrodes TE, overlapping between the plurality of first electrodes E1 and the plurality of touch electrodes TE, and overlapping between the plurality of second electrodes E2 and the plurality of touch electrodes TE should be reduced or minimized, particularly when the plurality of touch electrodes TE includes mesh lines. FIG. 11 is a schematic diagram of a zoom-in region in an electronic apparatus in some embodiments according to the present disclosure. Referring to FIG. 11, a respective light emitting element of the plurality of light emitting elements LE is surrounded by mesh lines ML of the touch control structure. A respective first electrode of the plurality of first electrodes E1 crosses over the mesh lines ML multiple times (rather than non-crossing over) to minimize overlapping between the respective first electrode and the mesh lines ML. A respective second electrode of the plurality of second electrodes E2 crosses over the mesh lines ML multiple times to minimize overlapping between the respective second electrode and the mesh lines ML.

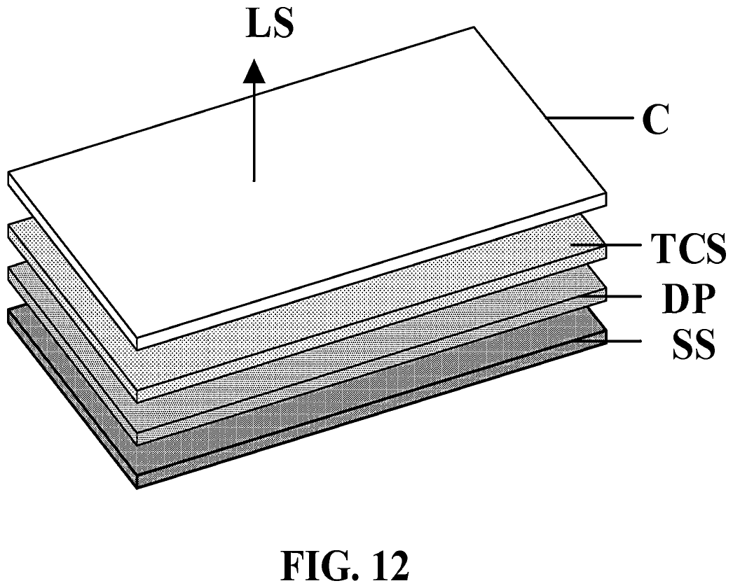

FIG. 12 illustrates an arrangement of a stacked structure in an electronic apparatus in some embodiments according to the present disclosure. Referring to FIG. 12, the electronic apparatus in some embodiments further includes a support structure SS on a side opposite to a light emitting side LS of the display panel DP. In some embodiments, the pyroelectric layer, the first electrode layer, and the second electrode layer are integrated into the support structure are integrated into the support structure SS.

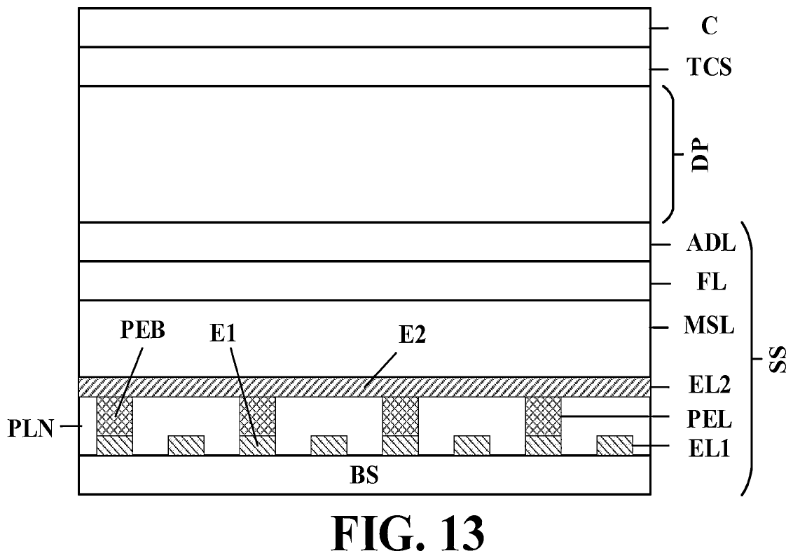

FIG. 13 is a cross-sectional view of an electronic apparatus in some embodiments according to the present disclosure. Referring to FIG. 13, the support structure SS in some embodiments includes a flexible base substrate, which functions as the base substrate BS for forming the pyroelectric structure. Referring to FIG. 12 and FIG. 13, the first electrode layer EL1 is on a side of the flexible base substrate closer to the display panel DP, the pyroelectric layer PEL is on a side of the first electrode layer EL1 away from the flexible base substrate, and the second electrode layer EL2 is on a side of the pyroelectric layer PEL away from the first electrode layer EL1.

In some embodiments, the support structure SS further includes a metal support layer MSL on a side of the second electrode layer EL2 away from the flexible base substrate; a foam layer FL on a side of the metal support layer MSL away from the second electrode layer EL2; and an adhesive layer ADL on a side of the foam layer FL away from the metal support layer MSL, adhering the support structure SS to the display panel DP. The metal support layer MSL may be made of any appropriate metallic material such as copper. The foam layer FL may be made of any appropriate organic polymer material. Examples of appropriate organic polymer materials for making the foam layer FL include polyethylene terephthalate. The adhesive layer ADL may be made of any appropriate adhesive material such as an optically clear resin.

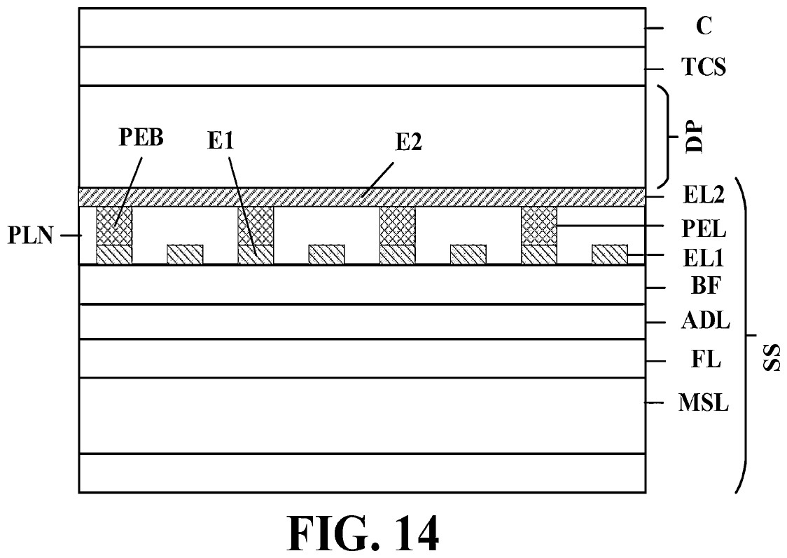

FIG. 14 is a cross-sectional view of an electronic apparatus in some embodiments according to the present disclosure. Referring to FIG. 14, the electronic apparatus in some embodiments includes a back film BF between the display panel DP and the adhesive layer ADL of the support structure SS. The back film BF functions as the base substrate for forming the pyroelectric structure. Referring to FIG. 12 and FIG. 14, the first electrode layer EL1 is on a side of the back film BF closer to the display panel DP, the pyroelectric layer PEL is on a side of the first electrode layer EL1 away from the back film BF, and the second electrode layer EL2 is on a side of the pyroelectric layer PEL away from the first electrode layer EL1.

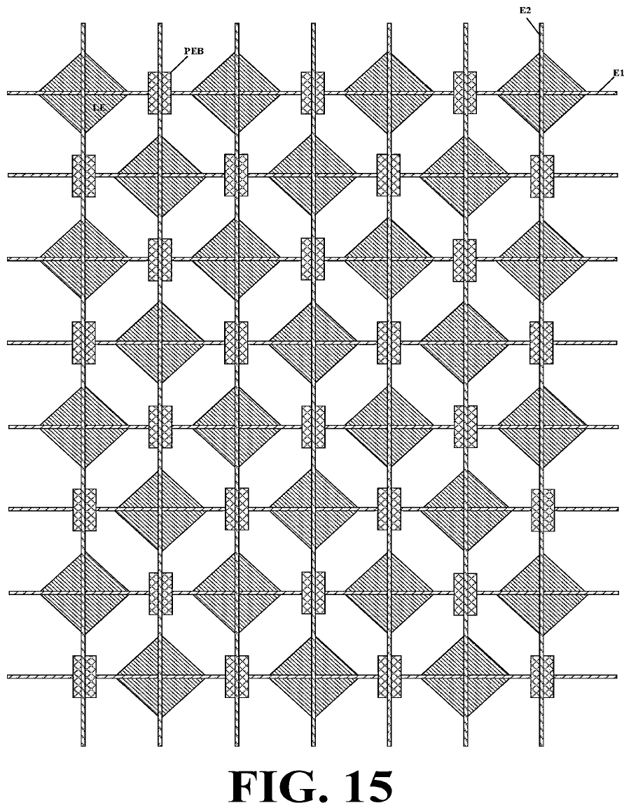

In some embodiments, the first electrode layer and the second electrode layer are made of a transparent electrode material. FIG. 15 is a schematic diagram illustrating the structure of an electronic apparatus in some embodiments according to the present disclosure. Referring to FIG. 15, a respective first electrode of the plurality of first electrodes E1 crosses over multiple light emitting elements (e.g., in a row) of the plurality of light emitting elements LE. A respective second electrode of the plurality of second electrodes E2 crosses over multiple light emitting elements (e.g., in a column) of the plurality of light emitting elements LE. A respective pyroelectric block of the plurality of pyroelectric blocks PEB is surrounded by four adjacent light emitting elements.

Optionally, the plurality of light emitting elements are a plurality of light emitting diodes. In one example, the plurality of light emitting diodes are a plurality of organic light emitting diodes. In another example, the plurality of light emitting diodes are a plurality of micro light emitting diodes. In another example, the plurality of light emitting diodes are a plurality of mini light emitting diodes.

Optionally, the display panel is a liquid crystal display panel.

Optionally, the display panel is a light emitting diode display panel.

Examples of appropriate electronic apparatuses include, but are not limited to, an electronic paper, a mobile phone, a tablet computer, a television, a monitor, a notebook computer, a digital album, a GPS, etc. Optionally, the electronic apparatus is an organic light emitting diode display apparatus. Optionally, the electronic apparatus is a liquid crystal display apparatus.

In another aspect, the present disclosure provides a method of detecting a gesture input on an electronic apparatus. The electronic apparatus in some embodiments includes a pyroelectric layer comprising a plurality of pyroelectric blocks in an array; a first electrode layer comprising a plurality of first electrodes, a respective first electrode of the plurality of first electrodes electrically connected to multiple pyroelectric blocks; a second electrode layer comprising a plurality of second electrodes, a respective second electrode of the plurality of second electrodes electrically connected to multiple pyroelectric blocks; and a first circuit connected to the plurality of first electrodes and the plurality of second electrodes.

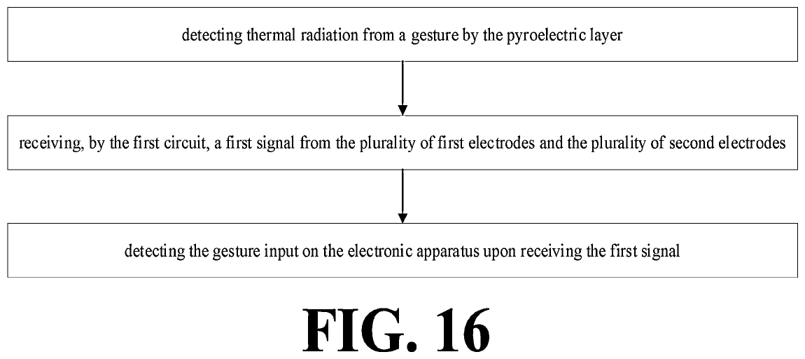

FIG. 16 is a flow chart illustrating a process of detecting a gesture input on an electronic apparatus in some embodiments according to the present disclosure. Referring to FIG. 16, the method in some embodiments includes detecting thermal radiation from a gesture by the pyroelectric layer; receiving, by the first circuit, a first signal from the plurality of first electrodes and the plurality of second electrodes; and detecting the gesture input on the electronic apparatus upon receiving the first signal.

In some embodiments, the method further includes establishing a first database configured to store data on a distribution pattern of heat generated by the electronic apparatus in operation over the pyroelectric layer. Optionally, the step of establishing the first database includes measuring the data on the distribution pattern of heat generated by the electronic apparatus in operation over the pyroelectric layer every time when the electronic apparatus is starting up. Optionally, the step of establishing the first database includes updating the data on the distribution pattern of heat generated by the electronic apparatus in operation over the pyroelectric layer when the electronic apparatus is on.

Optionally, the step of establishing the first database further includes measuring data on heat generated by one or more environmental objects that induces an electric signal in one or more pyroelectric blocks. Optionally, the step of measuring data on heat generated by one or more environmental objects is performed periodically and in real time.

In some embodiments, the method further includes converting the first signal into a second signal by canceling a noise in the first signal contributed by the heat generated by the electronic apparatus in operation over the pyroelectric layer.

Optionally, the method further includes converting the first signal into a second signal by canceling a noise in the first signal contributed by one or more environmental objects other than the electronic apparatus. Optionally, the one or more environmental objects may be a heat source. Optionally, the one or more environmental objects may be a cold source. Examples of environmental objects include sunlight, air flow (hot air or cold air), a heating light source, etc.

In some embodiments, the method further includes establishing a second database configured to store data on correspondence between a plurality of gesture inputs and a plurality of commands. Each gesture input corresponds to one or more commands. Each command corresponds to one or more gesture inputs.

In some embodiments, the method further includes generating a command signal based on the correspondence and upon detection of the gesture input. Optionally, the method further includes driving the electronic apparatus to perform an operation based on a command corresponding to the gesture input. In one example, the operation may include activating a virtual object displayed on a display panel.

The electronic apparatus of the present disclosure finds a wide variety of applications. In one example, the electronic apparatus is a vehicular display apparatus, the gesture control enabled by the present disclosure allows a user to provide gesture input to the vehicular display apparatus, particularly when other methods of control (e.g., touch control or voice control) cannot be easily applied. In another example, the electronic apparatus is a gym equipment such as a treadmill. Touch control of the gym equipment is difficult when the user is exercising, and the noisy ambient sound in a gym makes voice control infeasible. The present disclosure thus provides a highly sensitive user-machine interactive method, enhancing the safety of the user.

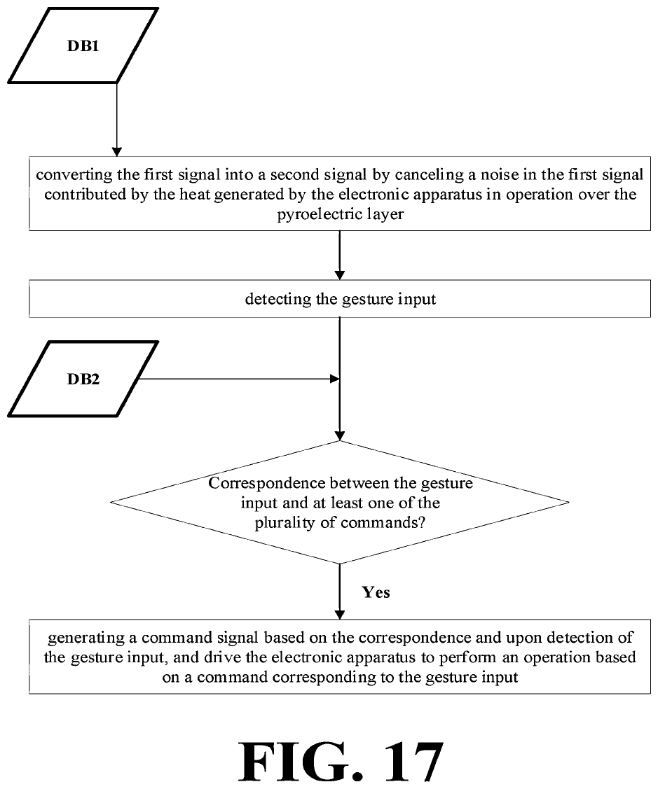

FIG. 17 is a flow chart illustrating a process of detecting a gesture input on an electronic apparatus in some embodiments according to the present disclosure. Referring to FIG. 17, the method in some embodiments includes, based on a first database DB1 storing data on a distribution pattern of heat generated by the electronic apparatus in operation over the pyroelectric layer, converting the first signal into a second signal by canceling a noise in the first signal contributed by the heat generated by the electronic apparatus in operation over the pyroelectric layer. Based on the second signal, a gesture input is detected. Next, based on a second database DB2 storing data on correspondence between a plurality of gesture inputs and a plurality of commands, the method further includes determining whether or not there is a correspondence between the gesture input detected and at least one of the plurality of commands. Upon determination that there is a correspondence between the gesture input detected and at least one of the plurality of commands, the method further includes generating a command signal based on the correspondence and upon detection of the gesture input, and drive the electronic apparatus to perform an operation based on a command corresponding to the gesture input.

In another aspect, the present disclosure provides a method of fabricating an electronic apparatus. In some embodiments, the method includes forming a pyroelectric layer comprising a plurality of pyroelectric blocks in an array, configured to detect thermal radiation from a gesture; forming a first electrode layer comprising a plurality of first electrodes, a respective first electrode of the plurality of first electrodes electrically connected to multiple pyroelectric blocks; forming a second electrode layer comprising a plurality of second electrodes, a respective second electrode of the plurality of second electrodes electrically connected to multiple pyroelectric blocks; and forming a first circuit configured to receive a first signal transmitted from the plurality of first electrodes and the plurality of second electrodes, and configured to detect a gesture input on the electronic apparatus upon receiving the first signal.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An electronic apparatus, comprising:
a pyroelectric layer comprising a plurality of pyroelectric blocks in an array, configured to detect thermal radiation from a gesture;
a first electrode layer comprising a plurality of first electrodes, a respective first electrode of the plurality of first electrodes electrically connected to multiple pyroelectric blocks;
a second electrode layer comprising a plurality of second electrodes, a respective second electrode of the plurality of second electrodes electrically connected to multiple pyroelectric blocks; and
a first circuit configured to receive a first signal transmitted from the plurality of first electrodes and the plurality of second electrodes, and configured to detect a gesture input on the electronic apparatus upon receiving the first signal.

2. The electronic apparatus of claim 1, further comprising a non-transitory memory comprising a first database configured to store data on a distribution pattern of heat generated by the electronic apparatus in operation over the pyroelectric layer.

3. The electronic apparatus of claim 2, further comprising a second circuit configured to convert the first signal into a second signal by canceling a noise in the first signal contributed by the heat generated by the electronic apparatus in operation over the pyroelectric layer.

4. The electronic apparatus of claim 1, further comprising a non-transitory memory comprising a second database configured to store data on correspondence between a plurality of gesture inputs and a plurality of commands.

5. The electronic apparatus of claim 4, further comprising a second circuit configured to generate a command signal based on the correspondence and upon detection of the gesture input, and drive the electronic apparatus to perform an operation based on a command corresponding to the gesture input.

6. The electronic apparatus of claim 5, wherein the operation comprises activating a virtual object displayed on a display panel.

7. The electronic apparatus of claim 1, further comprising a display panel configured to display an image in a display area;
wherein the plurality of pyroelectric blocks are at least partially in the display area.

8. The electronic apparatus of claim 7, further comprising a touch control structure on a light emitting side of the display panel;
wherein the pyroelectric layer, the first electrode layer, and the second electrode layer are on a side of the touch control structure away from the display panel.

9. The electronic apparatus of claim 7, wherein the display area comprises a plurality of subpixel regions and an inter-subpixel region; and
the plurality of pyroelectric blocks, the plurality of first electrodes, and the plurality of second electrodes are in the inter-subpixel region.

10. The electronic apparatus of claim 7, wherein the plurality of first electrodes and the plurality of second electrodes cross over each other forming a plurality of intersections; and
the plurality of pyroelectric blocks are in the plurality of intersections, respectively, and between the first electrode layer and the second electrode layer.

11. The electronic apparatus of claim 7, further comprising a support structure on a side opposite to a light emitting side of the display panel;
wherein the pyroelectric layer, the first electrode layer, and the second electrode layer are integrated into the support structure.

12. The electronic apparatus of claim 11, wherein the support structure comprises a flexible base substrate;
the first electrode layer is on a side of the flexible base substrate closer to the display panel;
the pyroelectric layer is on a side of the first electrode layer away from the flexible base substrate; and
the second electrode layer is on a side of the pyroelectric layer away from the first electrode layer.

13. The electronic apparatus of claim 12, wherein the flexible base substrate is a back film of the display panel; and
the pyroelectric layer, the first electrode layer, and the second electrode layer are between the back film and the display panel.

14. The electronic apparatus of claim 12, wherein the support structure further comprises:
a metal support layer on a side of the second electrode layer away from the flexible base substrate;
a foam layer on a side of the metal support layer away from the second electrode layer; and
an adhesive layer on a side of the foam layer away from the metal support layer, adhering the support structure to the display panel.

15. A method of detecting a gesture input on an electronic apparatus,
wherein the electronic apparatus comprises:
a pyroelectric layer comprising a plurality of pyroelectric blocks in an array;
a first electrode layer comprising a plurality of first electrodes, a respective first electrode of the plurality of first electrodes electrically connected to multiple pyroelectric blocks;
a second electrode layer comprising a plurality of second electrodes, a respective second electrode of the plurality of second electrodes electrically connected to multiple pyroelectric blocks; and
a first circuit connected to the plurality of first electrodes and the plurality of second electrodes;
the method comprises:
detecting thermal radiation from a gesture by the pyroelectric layer;
receiving, by the first circuit, a first signal from the plurality of first electrodes and the plurality of second electrodes; and
detecting the gesture input on the electronic apparatus upon receiving the first signal.

16. The method of claim 15, further comprising establishing a first database configured to store data on a distribution pattern of heat generated by the electronic apparatus in operation over the pyroelectric layer.

17. The method of claim 16, further comprising converting the first signal into a second signal by canceling a noise in the first signal contributed by the heat generated by the electronic apparatus in operation over the pyroelectric layer.

18. The method of claim 15, further comprising establishing a second database configured to store data on correspondence between a plurality of gesture inputs and a plurality of commands.

19. The method of claim 18, further comprising generating a command signal based on the correspondence and upon detection of the gesture input, and drive the electronic apparatus to perform an operation based on a command corresponding to the gesture input.

20. The method of claim 19, wherein the operation comprises activating a virtual object displayed on a display panel.
